(19) United States
(12) Patent Application Publication
(10) Pub. No.: US 2002/0067029 A1
(43) Pub. Date: Jun. 6, 2002

(54) Mounting arrangement for an airbag module

(76) Inventors: Detlev Wilhelm Guthke, Hagen (DE); Hans Gert Nilson, Wuppertal (DE)

Correspondence Address: KATHRYN A. MARRA, DELPHI TECHNOLOGIES, INC., P.O. Box 5052, Mail Code: 480-414-420, Troy, MI, 48007-5052, US

(21) Appl. No.: 09/731,269

(22) Filed: Dec. 6, 2000

(51) Int. Cl. B60R 21/16; B60R 21/26

(52) U.S. Cl. 280/730.2; 280/728.2; 280/736

(57) ABSTRACT

An airbag module (10) comprising an airbag (14) having an extended profile; a longitudinally extending structural member (16) positioned inside the airbag; and at least two mounting devices (12) for mounting the airbag module in position; each mounting device comprising a first part (22) and a second part (24); each first part being positioned inside the airbag and having a first portion (32) making a sliding fit on the structural member, and an upstanding portion (34) having a predefined shape; each second part being positioned outside the airbag and having a first portion (36) with a slot (38) of predefined shape for receiving the upstanding portion and a portion (28) of the airbag in a tight fit, and a second portion (40) for mounting the airbag module. Provides a mounting arrangement for an airbag module without the need for an aperture in the airbag.

### TECHNICAL FIELD

The present invention relates to an airbag module in which the airbag has an extended or longitudinally extending shape, and, in particular, an arrangement for mounting such an airbag module.

### BACKGROUND OF THE INVENTION

Airbag modules having extended or longitudinally extending airbags are known, and are sometimes referred to as side curtains or side airbags. Such airbag modules can be mounted in the roof or door of a motor vehicle adjacent the side of an occupant seat, in general to provide protection for an occupant during a side impact on the vehicle or during roll-over. It is generally a requirement of such airbag modules that the airbag or cushion remains inflated for a longer period of time when compared to the airbags of airbag modules mounted in the dashboard or steering wheel of a motor vehicle.

### SUMMARY OF THE INVENTION

It is an object of the present invention to provide a mounting arrangement for such an airbag module in which the mounting arrangement does not require apertures to be formed in the airbag or curtain.

An airbag module in accordance with the present invention comprises an airbag having an extended profile; a longitudinally extending structural member positioned inside the airbag; and at least two mounting devices for mounting the airbag module in position; each mounting device comprising a first part and a second part; each first part being positioned inside the airbag and having a first portion making a sliding fit on the structural member, and an upstanding portion having a predefined shape; each second part being positioned outside the airbag and having a first portion with a slot of predefined shape for receiving the upstanding portion and a portion of the airbag in a tight fit, and a second portion for mounting the airbag module.

The present invention provides a mounting arrangement for an airbag module which does not require the formation of apertures in the airbag.

### BRIEF DESCRIPTION OF THE DRAWINGS

The present invention will now be described, by way of example, with reference to the accompanying drawings, in which:

FIG. 1 is a side view of an airbag module in accordance with the present invention;

FIG. 2 is an exploded view of the airbag module of FIG. 1;

and

FIG. 3 is a cross-sectional view of the mounting device of the airbag module of FIG. 1.

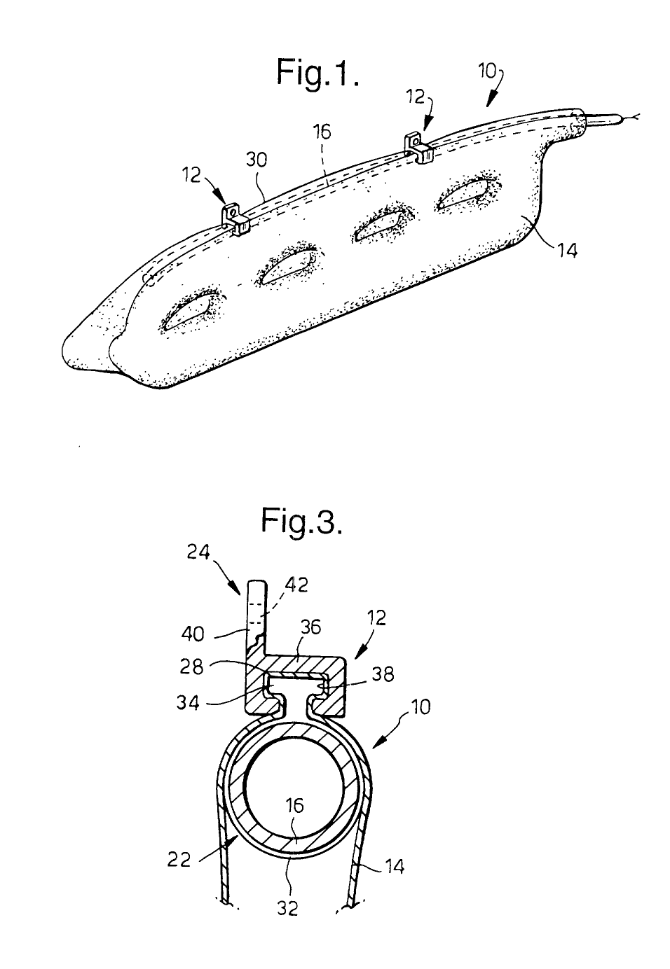

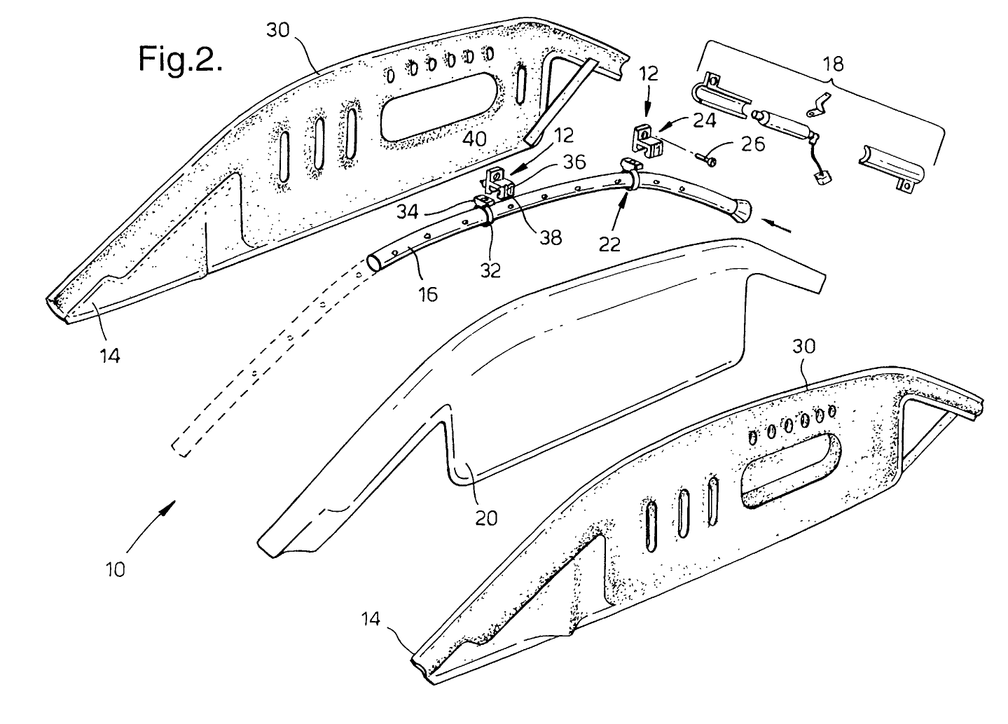

### DESCRIPTION OF THE PREFERRED EMBODIMENT

Referring to the drawings, the airbag module 10 in accordance with the present invention is for use in a motor vehicle and comprises an airbag or cushion 14 having an extended profile; a longitudinally extending structural member 16; and a pair of mounting devices 12. The structural member 16 is positioned inside the airbag 14. The structural member 16 may be a gas lance or gas diffuser tube which is connected to an inflator 18 for the flow of inflation gas from the inflator into the airbag 14 during deployment of the airbag. In the latter case, the inflator may be secured to the structural member 16 at the position where the structural member enters the airbag 14. A heat shield 20 may be positioned inside the airbag 14.

Each mounting device 12 comprises a first part 22 which is attached to the structural member 16, and a second part 24 which is secured to the motor vehicle, for example, by screws 26 or by a snap-fit. The first and second parts 22,24 are secured together in such a way that a portion 28 of one edge 30 of the airbag 14 is trapped and secured between the first and second parts.

In the preferred arrangement shown in the drawings, the first part 22 of each mounting device 12 comprises a substantially annular portion 32 which makes a sliding fit on the structural member 16, and an upstanding portion 34 which is substantially T-shaped and which is integral with the annular portion. The first part 22 is attached to the structural member 16 inside the airbag 14. The second part 24 of each mounting device 12 comprises a first portion 36 which has a T-shaped slot 38, and a second portion 40 which has an aperture 42 for the screw 26. The T-shaped portion 34 of the first part 22 and the portion 28 of the airbag 14 make a tight fit inside the T-shaped slot 38.

In the present invention, therefore, the airbag 14 of the airbag module 10 can be secured to the motor vehicle without creating apertures in the airbag. Further, the first part 22 of each mounting device 12 can be slid axially along the structural member 16, during mounting of the airbag module 10, to take up any axial tolerances during mounting. Still further, the first part 22 of each mounting device may be rotated relative to the structural member 16 to ensure the correct orientation of the airbag 14.

The annular portion 32 of the first part 22 of each mounting device 12 may be replaced by a C-shaped portion which makes a sliding-fit on the structural member 16. The T-shaped portion 34 and the T-shaped slot 38 may be replaced any another other suitable shapes for these portions. The second portion 40 of the second part 24 may be any suitable mounting portion.

1. An airbag module comprising an airbag having an extended profile; a longitudinally extending structural member positioned inside the airbag; and at least two mounting devices for mounting the airbag module in position; each mounting device comprising a first part and a second part; each first part being positioned inside the airbag and having a first portion making a sliding fit on the structural member, and an upstanding portion having a predefined shape; each second part being positioned outside the airbag and having a first portion with a slot of predefined shape for receiving the upstanding portion and a portion of the airbag in a tight fit, and a second portion for mounting the airbag module.

2. An airbag module as claimed in claim 1, wherein the structural member is a gas tube for delivering inflation gas to the airbag during deployment of the airbag.

3. An airbag module as claimed in claim 1 or claim 2, wherein the first portion of the first part of each mounting device is annular.

4. An airbag module as claimed in any one of claims 1 to 3, wherein the upstanding portion of the first part of each mounting device, and the slot of the first portion of the second part of each mounting device are substantially T-shaped.
